(19) United States
(12) Patent Application Publication
(10) Pub. No.: US 2026/0101175 A1
(43) Pub. Date: Apr. 9, 2026

(54) USER EQUIPMENT CAPABILITY FRAMEWORK IN A WIRELESS COMMUNICATIONS SYSTEM

(71) Applicant: Lenovo (United States) Inc., Morrisville, NC (US)

(72) Inventors: Hyung-Nam Choi, Ottobrunn (DE); Joachim Löhr, Wiesbaden (DE); Tapisha Soni, Munich (DE)

(21) Appl. No.: 19/415,504

(22) Filed: Dec. 10, 2025

(51) Int. Cl. H04W 8/22; H04W 76/20

(52) U.S. Cl. CPC H04W 8/22; H04W 76/20

(57) ABSTRACT

Various aspects of the present disclosure relate to enhanced, updated, and/or new user equipment (UE) capability framework that may introduce procedures for signaling dynamic and static capabilities to a requesting network node. The UE may store or otherwise maintain a variable that represents values (e.g., statuses) for the various dynamic and static capabilities of the UE. Further, the network node may request the UE to provide the UE capability information. Having knowledge of the dynamic and static capabilities of a UE, the RAN node may signal UE configurations that are based on a current status of the capabilities of the UE.

### TECHNICAL FIELD

The present disclosure relates to wireless communications, and more specifically to the signaling of user equipment (UE) capabilities.

### BACKGROUND

A wireless communications system may include one or multiple network communication devices, which may be otherwise known as network equipment (NE), supporting wireless communications for one or multiple user communication devices, which may be otherwise known as UEs, or other suitable terminology. The wireless communications system may support wireless communications with one or multiple user communication devices by utilizing resources of the wireless communications system (e.g., time resources (e.g., symbols, slots, subframes, frames, or the like)) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., 5G-advanced (5G-A), sixth generation (6G)).

### SUMMARY

As used herein, including the claims, an article “a” before an element is unrestricted and understood to refer to “at least one” of those elements or “one or more” of those elements. The terms “a,” “at least one,” “one or more,” and “at least one of one or more” may be interchangeable.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.

As used herein, including in the claims, a “set” may include one or more elements.

The present disclosure relates to methods, apparatuses, and systems for the signaling of UE capabilities, such as the signaling of static UE capabilities and/or dynamic UE capabilities.

A UE for wireless communication is described. The UE may be configured to, capable of, or operable to perform one or more operations as described herein. For example, the UE may comprise one or more memories and one or more processors coupled with the one or more memories and individually or collectively configured to cause the UE to transmit UE capability information comprising a first set of one or more static capabilities of the UE or a second set of one or more dynamic capabilities of the UE, or both, wherein the first set of one or more static capabilities is different than the second set of one or more dynamic capabilities.

A processor (e.g., a standalone processor chipset, or a component of a UE) for wireless communication is described. The processor may be configured to, capable of, or operable to perform one or more operations as described herein. For example, the processor may comprise one or more memories and one or more controllers coupled with the one or more memories and individually or collectively configured to cause the processor to transmit UE capability information comprising a first set of one or more static capabilities of the UE or a second set of one or more dynamic capabilities of the UE, or both, wherein the first set of one or more static capabilities is different than the second set of one or more dynamic capabilities.

A method performed or performable by the UE is described. The method may comprise transmitting UE capability information comprising a first set of one or more static capabilities of the UE or a second set of one or more dynamic capabilities of the UE, or both, wherein the first set of one or more static capabilities is different than the second set of one or more dynamic capabilities.

In some implementations of the UE, processor, and method described herein, the UE, processor, and method may further be configured to, capable of, performed, performable, or operable to receive a UE capability request for the first set of one or more static capabilities of the UE or the second set of one or more dynamic capabilities of the UE, or both and transmit a UE capability response based at least in part on the received UE capability request, wherein the UE capability response comprises the UE capability information.

In some implementations of the UE, processor, and method described herein, the UE, processor, and method may further be configured to, capable of, performed, performable, or operable to store a variable comprising a respective value for each static capability of the first set of one or more static capabilities and for each dynamic capability of the second set of one or more dynamic capabilities, wherein the UE capability information is based at least in part on the stored variable.

In some implementations of the UE, processor, and method described herein, the respective value for each static capability of the first set of one or more static capabilities and for each dynamic capability of the second set of one or more dynamic capabilities is indicative of whether a respective static capability or a respective dynamic capability is supported by the UE, not supported by the UE, supported by the UE and applicable according to a current configuration, or supported and not applicable according to the current configuration.

In some implementations of the UE, processor, and method described herein, the UE, processor, and method may further be configured to, capable of, performed, performable, or operable to receive a reconfiguration message or a system information message and update the respective value for one or more static capabilities of the first set of one or more static capabilities or for one or more dynamic capabilities of the second set of one or more dynamic capabilities based at least in part on the received reconfiguration message or the received system information message.

In some implementations of the UE, processor, and method described herein, the UE capability information comprising the first set of one or more static capabilities of the UE or the second set of one or more dynamic capabilities of the UE, or both, is transmitted based at least in part on the received reconfiguration message or the received system information message.

In some implementations of the UE, processor, and method described herein, the UE, processor, and method may further be configured to, capable of, performed, performable, or operable to transmit a response message based at least in part on the received reconfiguration message, wherein the response message indicates a failure for reconfiguration and a cause value, and wherein the cause value is indicative of the failure for reconfiguration being based at least in part on whether the respective static capability or the respective dynamic capability is not supported by the UE or supported by the UE and not applicable according to the current configuration.

In some implementations of the UE, processor, and method described herein, the UE, processor, and method may further be configured to, capable of, performed, performable, or operable to update the respective value for one or more static capabilities of the first set of one or more static capabilities or for one or more dynamic capabilities of the second set of one or more dynamic capabilities based at least in part on a condition.

In some implementations of the UE, processor, and method described herein, the condition comprises a low power mode being enabled or disabled for the UE.

In some implementations of the UE, processor, and method described herein, the condition comprises: one or more static capabilities of the UE or one or more dynamic capabilities of the UE are not currently supported by the UE, the UE is experiencing a temporary shortage of one or more available resources, conditions associated with a network are suboptimal for supporting the one or more static capabilities of the UE or the one or more dynamic capabilities of the UE.

In some implementations of the UE, processor, and method described herein, the UE capability information comprising the first set of one or more static capabilities of the UE or the second set of one or more dynamic capabilities of the UE, or both, is transmitted in response to the updated respective value for one or more static capabilities of the first set of one or more static capabilities or for one or more dynamic capabilities of the second set of one or more dynamic capabilities.

A network entity for wireless communication is described. The network entity may be configured to, capable of, or operable to perform one or more operations as described herein. For example, the network entity may comprise one or more memories and one or more processors coupled with the one or more memories and individually or collectively configured to cause the network entity to transmit, to a UE, a UE capability request for a first set of one or more static capabilities of the UE or a second set of one or more dynamic capabilities of the UE, or both, and receive a UE capability response based at least in part on the received UE capability request, wherein the UE capability response comprises UE capability information.

A processor (e.g., a standalone processor chipset, or a component of a network entity) for wireless communication is described. The processor may be configured to, capable of, or operable to perform one or more operations as described herein. For example, the processor may be configured to, capable of, or operable to transmit, to a UE, a UE capability request for a first set of one or more static capabilities of the UE or a second set of one or more dynamic capabilities of the UE, or both, and receive a UE capability response based at least in part on the received UE capability request, wherein the UE capability response comprises UE capability information.

A method performed or performable by the network entity is described. The method may comprise transmitting, to a UE, a UE capability request for a first set of one or more static capabilities of the UE or a second set of one or more dynamic capabilities of the UE, or both, and receiving a UE capability response based at least in part on the received UE capability request, wherein the UE capability response comprises UE capability information.

In some implementations of the network entity, processor, and method described herein, the network entity, processor, and method may further be configured to, capable of, performed, performable, or operable to receive the UE capability response in response to a radio resource control (RRC) reconfiguration message or a radio resource control (RRC) system information message.

In some implementations of the network entity, processor, and method described herein, the network entity, processor, and method may further be configured to, capable of, performed, performable, or operable to cause the network entity to receive the UE capability response via an RRC UE capability information message or an RRC reconfiguration failure message.

### BRIEF DESCRIPTION OF THE DRAWINGS

FIG. 1 illustrates an example of a wireless communications system in accordance with aspects of the present disclosure.

FIG. 2 illustrates example wireless communications in accordance with aspects of the present disclosure.

FIGS. 3-5B illustrate messaging flows for messaging UE capability information in accordance with aspects of the present disclosure.

FIG. 6 illustrates an example of a UE in accordance with aspects of the present disclosure.

FIG. 7 illustrates an example of a processor in accordance with aspects of the present disclosure.

FIG. 8 illustrates an example of an NE in accordance with aspects of the present disclosure.

FIG. 9 illustrates a flowchart of a method performed by a UE in accordance with aspects of the present disclosure.

FIG. 10 illustrates a flowchart of a method performed by an NE in accordance with aspects of the present disclosure.

### DETAILED DESCRIPTION

Future radio access technologies (e.g., 6G and beyond) are expected to support wireless communications beyond the capabilities of current radio access technologies (e.g., 4G and 5G), delivering higher throughout, lower latency, and higher reliability. These next-generation radio access technologies are also expected to support advanced functionality and features, such as joint communication and sensing, artificial intelligence (AI)-enabled functions, and enhanced support for various categories (e.g., types, categories) of user communication devices, including Internet of Things (IoT) devices, extended reality (XR) devices, and other emerging UE categories.

However, existing UE capability frameworks (e.g., standardized for current radio access technologies), particularly aspects governing the signaling of UE capabilities are not equipped to effectively support next-generation capabilities. For example, current UE capability frameworks exhibit various limitations. In some cases, associated UE capability signaling and procedures are resource-intensive and overly complex. In some other cases, the current UE capability frameworks support only static capabilities (e.g., capabilities that are expected not to change, or change infrequently, over time). In other cases, a UE might lack awareness of corresponding network capabilities. In yet other cases, there may be occurrences of configuration failures at a UE due to incomplete, inconsistent, or unsupported capability combinations between the UE and the network.

Various aspects of the present disclosure introduce an enhanced (e.g., updated, and/or new) UE capability framework configured to address the foregoing limitations and to enable more efficient signaling of UE capability information in next-generation radio access technologies (e.g., 6G and future radio access technologies beyond 6G). In some examples, the enhanced UE capability framework may define procedures for reporting (e.g., signaling) dynamic and static capability information, for example, to the network (e.g., a base station, a RAN node, or the like). The UE may store or otherwise maintain a variable, data structure, or other representation that represents respective values (e.g., states or status indicators) associated with the various dynamic and static capabilities of the UE. In some examples, the network may request the UE to provide the UE capability information. Having knowledge of the dynamic and static capabilities of the UE, the network may signal UE configurations that are based at least in part on a current status of the capabilities of the UE.

Thus, the UE capability framework provides an effective and efficient signaling or exchange of UE capability information between UEs and NEs. The signaling enables the NEs to maintain current or up-to-date knowledge of capabilities (e.g., current statuses for static and/or dynamic capabilities) of the UEs and/or avoid configuration failures at the UEs, among other benefits. Further, the UE capability framework may enable dynamic updates of UE capabilities in response to temporary constraints or RRC configuration failures, such as updates that do not impact a core network or increase signaling overheads due to establishment of RRC connections, and/or adapt UE capability signaling to the capabilities of the UE and the RAN node (or other network node), among other benefits.

Aspects of the present disclosure are described in the context of a wireless communications system. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Although aspects of an NR system may be described for purposes of example, and NR terminology may be used in much of the description, the techniques described herein are applicable beyond NR networks. For example, the described techniques may be applicable to various other wireless communications systems such as Institute of Electrical and Electronics Engineers (IEEE) 802.11 (Wi-Fi), IEEE 802.16 (WiMAX), as well as other systems and radio technologies not explicitly mentioned herein. Thus, the present disclosure is not limited to the examples and implementations described herein but is to be accorded the broadest scope consistent with the principles and novel features disclosed herein.

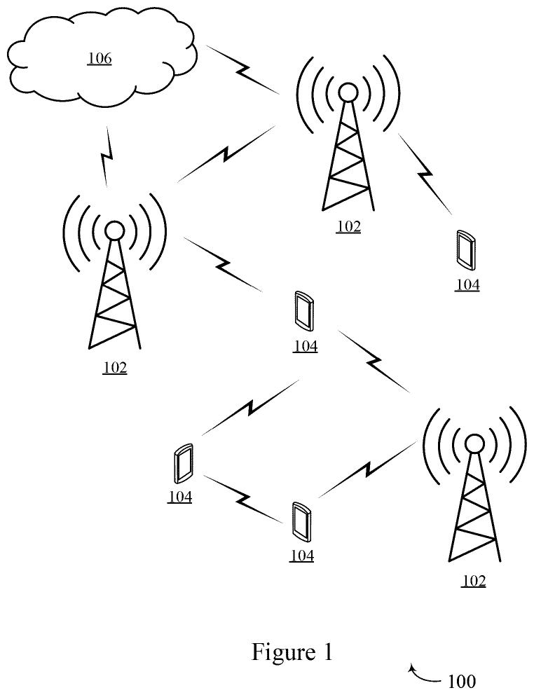

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be an NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), an access point (AP), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station (STA), a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, or network interface). In some implementations, the NE 102 may communicate with each other directly. In some other implementations, the NE 102 may communicate with each other indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management function (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signaling bearers, etc.) for the one or more UEs 104 served by the one or more NE 102 associated with the CN 106.

The CN 106 may communicate with a packet data network over one or more backhaul links (e.g., via an S1, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHZ-24.25 GHz), FR4 (52.6 GHz-114.25 GHZ), FR4a or FR4-1 (52.6 GHz-71 GHZ), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

As described herein, the wireless communications system 100 may implement a UE capability framework that facilitates the exchange of UE capability information (e.g., static and/or dynamic capabilities) between the UEs 104 and the NEs 102.

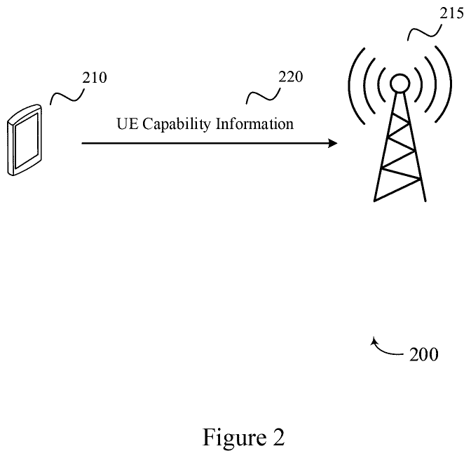

FIG. 2 illustrates an example of wireless communications 200 in accordance with aspects of the present disclosure. In some examples, the wireless communications 200 implements or is implemented by aspects of the wireless communications system 100. For example, the wireless communications 200 may be implemented by a UE 210 and a RAN node 215, which may be an example of UEs 104 and NEs 102 as described with reference to FIG. 1.

The UE 210, in various examples, transmits UE capability information 220 to the RAN node 215. The UE 210 may be configured to store or maintain a variable associated with capability types of the UE capability information 220, such as a value or parameter for each static capability of one or more static capabilities and a value or parameter for each dynamic capability of one or more dynamic capabilities. As described herein, a static UE capability may be a UE capability that is expected not to change, or not to change frequently, during operation of the UE 210, and a dynamic UE capability may be a UE capability that is expected to change frequently during UE operations (e.g., due to temporary constraints at the UE (e.g., overload, power saving operations), RRC configuration failures, and so on).

For example, the UE capability information 220 may include a variable UECapabilityInformation that comprises the parameters ue-CapabilityList-Static and ue-CapabilityList-Dynamic. In some cases, the RAN node 215 may transmit a request message (e.g., a UJECapabilityEnquiry message) using the parameters ue-CapabilityRequestList-Static and ue-CapabilityRequestList-Dynamic, or may request the UE capability information 220 via an RRC reconfiguration or RRC Setup message (e.g., RRCReconfiguration or RRCSetup). Upon receipt, the RAN node 215, in some cases, may send the received UE capability information 220 to another RAN node or network node (e.g., during mobility procedures) and/or to a network node of the CN 106 for local storage.

For each of the parameters, the UE 210 may indicate one or more of the following values:
“notSupported”: where the capability is not supported by the UE 210;
“supported”: where the capability is supported by the UE 210;
“active”: where the capability is supported by the UE 210 and applied according to a current RRC configuration;
“inactive”: where the capability is supported by the UE 210 but not applied according to a current RRC configuration;
“inapplicable”: where a concerned capability is supported by the UE 210 but is inapplicable due to temporary constraints or an RRC configuration failure; and so on.

The contents of the UE capability information 220 may include both types of UE capabilities (e.g., the static and dynamic types of capabilities) or a single type of UE capabilities (e.g., the static or dynamic type of capabilities), which may indicate only the type of UE capabilities that have changed.

The following is an example UECapabilityInformation message and example UECapabilityEnquiry message (e.g., in ASN.1 format) transmitted between the UE 210 and the RAN node 215:

```
    UECapability Information ::= SEQUENCE {
      ue-CapabilityList-Static UE-CapabilityList-Static OPTIONAL,
      ue-CapabilityList-Dynamic UE-CapabilityList-Dynamic OPTIONAL
    }
    UE-CapabilityList-Static ::= SEQUENCE {
      ue-StaticParameter1 ENUMERATED {notSupported, supported, active,
inactive, inapplicable},
      ue-StaticParameter2 ENUMERATED {notSupported, supported, active,
inactive, inapplicable},
        ...
    }
    UE-CapabilityList-Dynamic ::= SEQUENCE {
      ue-DynamicParameter1 ENUMERATED {notSupported, supported, active,
inactive, inapplicable},
      ue-DynamicParameter2 ENUMERATED {notSupported, supported, active,
inactive, inapplicable},
        ...
    }
    UECapabilityEnquiry ::= SEQUENCE {
      ue-CapabilityRequestList-Static ENUMERATED {true}
  OPTIONAL,
        ue-CapabilityRequestList-Dynamic ENUMERATED {true}
  OPTIONAL
    }
```

In some examples, the UE 210 may transmit the UE capability information 220 to indicate an RRC reconfiguration failure at the UE 210. For example, the UE 210 may receive an RRC reconfiguration request from the RAN node 215 that causes a configuration, or reconfiguration, failure at the UE 210. In response, the UE 210 may employ the UE capability framework to transmit, via the UE capability information 220, one or more indications to the RAN node 215:
a “configuration not supported” indication, when the UE 210 receives an RRC configuration for a feature not supported by the UE 210;
an “incomplete configuration” indication, when the UE 210 receives an incomplete RRC configuration for a feature supported by the UE 210 (e.g., one or more parameters are missing in the RRC configuration);
an “incorrect configuration” indication, when the UE 210 receives an RRC configuration with one or more incorrect parameter values for a feature supported by the UE 210;
a “deferred configuration” indication, when the UE 210 receives an RRC configuration for a feature supported by the UE 210 but the UE 210 is under a temporary constraint (e.g., insufficient processing capability or power) that causes the UE 210 to defer the RRC configuration; and so on.

Table 1 presents an example format of an RRCReconfiguration message, where N (e.g., N=1-16) RRC configurations may be signaled by the RAN node 215 via the RRCReconfiguration message.

TABLE 1

| RRCReconfiguration | Description |
|---|---|
| >Configuration 1 | Contains the RRC configuration for feature 1. |
| >>Configuration index 1 | Indicates the index of the configuration for |
| | feature 1. |
| >>Configuration | Contains the required set of parameters for the |
| parameter set 1 | configuration of feature 1. |
| >Configuration 2 | Contains the RRC configuration for feature 2. |
| >>Configuration index 2 | Indicates the index of the configuration for |
| | feature 2. |
| >>Configuration | Contains the required set of parameters for the |
| parameter set 2 | configuration of feature 2. |
| . . . | |
| >Configuration N | Contains the RRC configuration for feature N. |
| >>Configuration index N | Indicates the index of the configuration for |
| | feature N. |
| >>Configuration | Contains the required set of parameters for the |
| parameter set N | configuration of feature N. |

Table 2 presents an example format of an RRCReconfigurationFailure message, where N (e.g., N=1-16) RRC configuration failure type indications may be signaled by the UE 210 via the RRCReconfigurationFailure message.

TABLE 2

| RRCReconfigurationFailure | Description |
|---|---|
| >Configuration 1 | Corresponds to the RRC configuration for |
| | feature 1. |
| >>Configuration index 1 | Indicates the index of the configuration for |
| | feature 1. |
| >>Configuration failure 1 | Indicates the failure type of the configuration |
| | for feature 1. |
| >Configuration 2 | Corresponds to the RRC configuration for |
| | feature 2. |
| >>Configuration index 2 | Indicates the index of the configuration for |
| | feature 2. |
| >>Configuration failure 2 | Indicates the failure type of the configuration |
| | for feature 2. |
| . . . | |
| >Configuration N | Corresponds to the RRC configuration for |
| | feature N. |
| >>Configuration index N | Indicates the index of the configuration for |
| | feature N. |
| >>Configuration failure N | Indicates the failure type of the configuration |
| | for feature N. |

As described herein, the UE 210 may store a variable associated with the different capability types of the UE capability information 220. For example, the UE 210 may store a new or distinguished variable (e.g., VarUE-CapabilityListStatus) to maintain or track the status of UE capability parameters. The variable may contain the parameters for static UE capabilities (e.g., via the UE-CapabilityList-Static parameter) and/or dynamic UE capabilities (e.g., via the UE-CapabilityList-Dynamic parameter). Example contents (e.g., in ASN.1 format) of the variable are as follows:

```
VarUE-CapabilityListStatus ::= SEQUENCE {
  ue-CapabilityList-Static UE-CapabilityList-Static OPTIONAL,
  ue-CapabilityList-Dynamic UE-CapabilityList-Dynamic OPTIONAL
}
```

In some cases, the UE 210 maintains the status of the UE capability parameters as follows:
The status of a parameter is set to “notSupported” or “supported” based on whether the UE 210 supports a corresponding feature or based on an exposure to network capabilities;
The status of a parameter changes from “supported” to “active” when a corresponding feature is configured or activated (e.g., based on an RRC configuration received from the RAN node 215);
The status of a parameter changes from “active” to “supported” when a corresponding feature is deactivated (e.g., based on the RRC configuration received from the RAN node 215);
The status of a parameter changes from “supported” to “inapplicable” or from “active” to “inapplicable” due to temporary constraints at the UE 210 and/or an RRC configuration failure; and so on.

Using the information stored in the variable (e.g., the VarUE-CapabilityListStatus variable), the UE 210 may transmit the UE capability information 220 with the latest or most recent status information for each of the parameters. Further, as described herein, the UE 210 may transmit the latest or most recent status information for each of the parameters via the UE capability information 220 in response to an RRC configuration failure or other failure event at the UE 210 (e.g., along with an indication of a type of the failure).

As described herein, the UE capability framework may be implemented in various different signaling scenarios or implementations. For each of the scenarios, an RRC connection between the UE 210 and the RAN node 215 is established, and the UE 210 is in an RRC_CONNECTED state. Further, the RAN node 215 has no information or knowledge about the UE capabilities of the UE 210, such as the capabilities shown in Table 3, as follows:

TABLE 3

| Feature | Capability | Definition | Per | Mandatory | Static/Dynamic |
|---|---|---|---|---|---|
| IMS (IP | voiceOver6G | Indicates whether the UE | UE | No | Static |
| Multimedia | | supports IMS voice over | | | |
| System | | 6G. | | | |
| Intra-RAT | handoverFR1-FR2 | Indicates whether the UE | UE | No | Static |
| mobility | | supports handover | | | |
| | | between FR1 and FR2. | | | |
| Inter-RAT | sa-NR | Indicates whether the | UE | No | Static |
| mobility | | UE supports standalone 5G NR. | | | |
| AIML | aiml-CSI- | Indicates whether the | UE | No | Dynamic |
| (artificial | Prediction | UE supports CSI | | | |
| intelligence | | prediction for UE-sided | | | |
| machine | | inference. | | | |
| learning) | | | | | |
| AIML | aiml-CSI- | Indicates whether the | UE | No | Dynamic |
| | Compression | UE supports CSI | | | |
| | | compression for UE-sided | | | |
| | | inference. | | | |
| UE power | drx-Adaptation | Indicates whether the | UE | No | Dynamic |
| saving | | UE supports DRX | | | |
| | | adaptation between short | | | |
| | | and long DRX cycles. | | | |

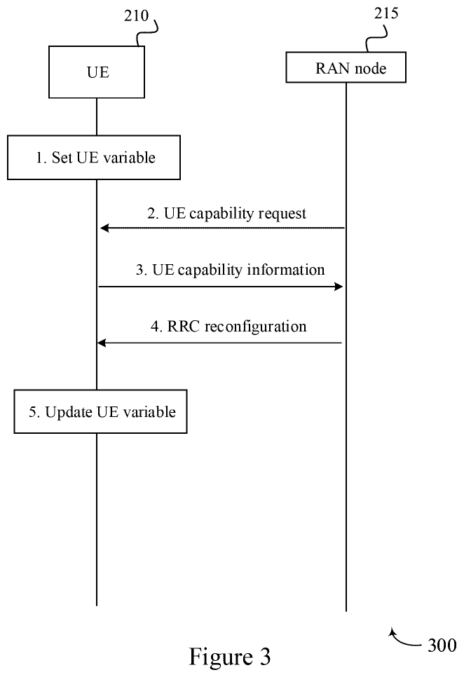

FIG. 3 illustrates a messaging flow 300 in accordance with aspects of the present disclosure and in support of a first example scenario. The messaging flow 300 may implement various aspects of the present disclosure described herein. For example, the messaging flow 300 may include the UE 210 and the RAN node 215, which may be examples of UEs and RAN nodes as described herein. In the following description of the messaging flow 300, the operations between the UE 210 and the RAN node 215 may be performed in different orders or at different times. Some operations may also be omitted, or other operations may be added. Although the UE 210 and the RAN node 215 are shown performing the operations of the messaging flow 300, some aspects of some operations may also be performed by other entities of the messaging flow 300 or by entities that are not shown in the messaging flow 300, or any combination thereof.

At step 1, the UE 210 sets a UE variable. For example, the UE 210 sets a variable VarUE-CapabilityListStatus, where a static capability “voiceOver6G” and a dynamic capability “aiml-CSI-Prediction” are set to “supported,” while other parameters are set to “notSupported.” Table 4 depicts the contents of the UE variable VarUE-CapabilityListStatus, as follows:

TABLE 4

| UE capability parameters | Value |
|---|---|
| >UE-CapabilityList-Static | |
| >>voiceOver6G | “supported” |
| >>handoverFR1-FR2 | “notSupported” |
| >>sa-NR | “notSupported” |
| >UE-CapabilityList-Dynamic | |
| >>aiml-CSI-Prediction | “supported” |
| >>aiml-CSI-Compression | “notSupported” |
| >>drx-Adaptation | “notSupported” |

At step 2, the RAN node 215 transmits a UE capability request to the UE 210. For example, the RAN node 215 sends a UE capability enquiry message to the UE 210 to request the static and dynamic capabilities (e.g., for 6G) for the UE 210. The UE capability enquiry message may include the parameters ue-CapabilityRequestList-Static and ue-CapabilityRequestList-Dynamic (e.g., set to “true”).

At step 3, the UE 210 transmits the UE capability information 220 to the RAN node 215. For example, in response to the received UE capability request, the UE 210 includes the requested UE capabilities (e.g., stored in the UE variable VarUE-CapabilityListStatus) in the UE capability information 220 and sends a message to the RAN node 215.

At step 4, the RAN node 215 sends an RRC reconfiguration message to the UE 210. For example, the RAN node 215, to configure the features IMS voice and AIML-enabled CSI prediction for the UE 210, the RAN node 215 sends an RRC reconfiguration message with contents shown in Table 5, as follows:

TABLE 5

| RRCReconfiguration | Description |
|---|---|
| >Configuration 1 | Contains the RRC configuration for |
| | feature IMS voice. |
| >>Configuration index 1 | Set to value “1.” |
| >>Configuration parameter | Contains the required set of parameters |
| set 1 | for the configuration of IMS voice. |
| >>>discardTimer | Upon expiry of the discard timer for |
| | a PDCP SDU, the transmitting PDCP |
| | entity discards the PDCP SDU. |
| | Value range = {10 ms, 20 ms, |
| | 40 ms, 50 ms, 75 ms, 100 ms}. |
| | Set to value 20 ms. |
| >>>headerCompression | Set to profile “0x0000”, e.g., |
| | no header compression. |
| >Configuration 2 | Contains the RRC configuration for |
| | feature AIML-enabled CSI prediction. |
| >>Configuration index 2 | Set to value “2.” |
| >>Configuration parameter | Contains the required set of parameters |
| set 2 | for the configuration of AIML-enabled |
| | CSI prediction. |
| >>>nrofReportedPredictedRS | Number of predicted RS resources to be |
| | reported by the UE. |
| | Value range = {1, 2, 3, 4}. |
| | Set to value “4.” |
| >>>resourcesForChannelPre- | Indicates the CSI resources to be used |
| diction | by the UE for prediction. |

At step 5, the UE 210 updates the stored UE variable. For example, the UE 210 updates the variable VarUE-CapabilityListStatus based on the received RRC reconfiguration message, such that the status of the static capability voiceOver6G and the status of the dynamic capability aiml-CSI-Prediction is changed from “supported” to “active.” Table 6 presents the updated UE variable, as follows:

TABLE 6

| UE capability parameters | Value |
|---|---|
| >UE-CapabilityList-Static | |
| >>voiceOver6G | “active” |
| >>handoverFR1-FR2 | “notSupported” |
| >>sa-NR | “notSupported” |
| >UE-CapabilityList-Dynamic | |
| >>aiml-CSI-Prediction | “active” |
| >>aiml-CSI-Compression | “notSupported” |
| >>drx-Adaptation | “notSupported” |

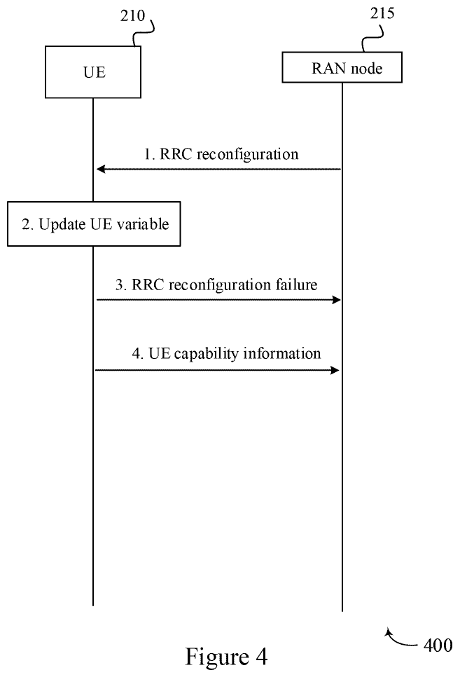

FIG. 4 illustrates a messaging flow 400 in accordance with aspects of the present disclosure and in support of a second example scenario. The messaging flow 400 may implement various aspects of the present disclosure described herein. For example, the messaging flow 400 may include the UE 210 and the RAN node 215, which may be examples of UEs and RAN nodes as described herein. In the following description of the messaging flow 400, the operations between the UE 210 and the RAN node 215 may be performed in different orders or at different times. Some operations may also be omitted, or other operations may be added. Although the UE 210 and the RAN node 215 are shown performing the operations of the messaging flow 400, some aspects of some operations may also be performed by other entities of the messaging flow 400 or by entities that are not shown in the messaging flow 400, or any combination thereof.

At step 1, the RAN node 215 transmits an RRC reconfiguration message to the UE 210. For example, the RAN node 215 transmits an RRC reconfiguration message to reconfigure the UE 210 for a UE feature of AIML-enabled CSI prediction. However, the RRC reconfiguration message includes a value for the parameter that is not defined for the parameter (e.g., nrofReportedPredictedRS value=8), as shown in Table 5.

At step 2, the UE 210 updates a UE variable. For example, the UE 210 determines that the received value=8 for the parameter nrofReportedPredictedRS is not applicable for the UE-side AI/ML model used for CSI prediction, and thus realizes an RRC configuration failure when the UE 210 attempts to update the VarUE-CapabilityListStatus based on the RRC reconfiguration message. In response, the UE 210 updates the parameter aiml-CSI-Prediction changing the value from “active” to “inapplicable,” as shown in Table 7, as follows:

TABLE 7

| UE capability parameters | Value |
|---|---|
| >UE-CapabilityList-Static | |
| >>voiceOver6G | “active” |
| >>handoverFR1-FR2 | “notSupported” |
| >>sa-NR | “notSupported” |
| >UE-CapabilityList-Dynamic | |
| >>aiml-CSI-Prediction | “inapplicable” |
| >>aiml-CSI-Compression | “notSupported” |
| >>drx-Adaptation | “notSupported” |

At step 3, the UE 210 transmits an RRC reconfiguration failure message to the RAN node 215. For example, in response to the RRC reconfiguration failure at the UE 210, the UE 210 sends the RRCReconfigurationFailure message to inform the RAN node 215 about the occurrence of the configuration failure. The RRCReconfigurationFailure message may include or indicate a failure type for the configuration of the feature AIML-enabled CSI prediction being set to “incorrect configuration.” For example, the RRCReconfigurationFailure message may include a cause value that is indicative of the failure for reconfiguration, such as a value that is based at least in part on whether a respective static capability or a respective dynamic capability is not supported by the UE 210.

At step 4, the UE 210 transmits the UE capability information 220 to the RAN node 215. For example, the UE 210 sends an unsolicited UE capability information message to inform the RAN node 215 about latest or current statuses of its UE capabilities. The UE capability information 220 may contain the status of each of the static and dynamic capabilities (e.g., as stored in the UE variable VarUE-CapabilityListStatus) or may only contain statuses of the dynamic capabilities stored in the UE variable. In some cases, the UE 210 may continue operation of the AIML-enabled CSI prediction based on a previously received RRC configuration or stop the operation of AIML-enabled CSI prediction.

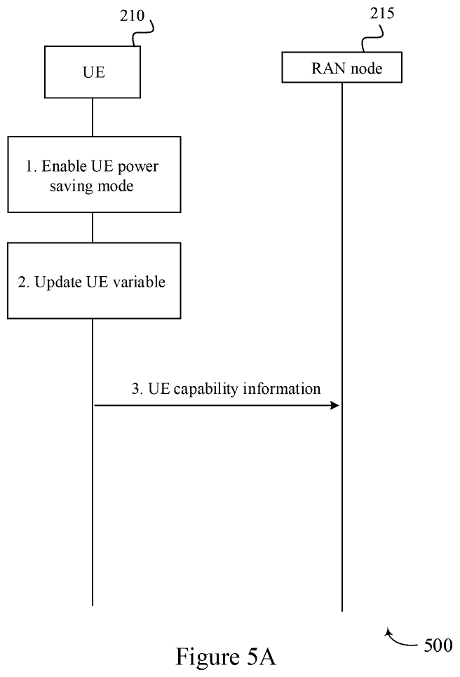

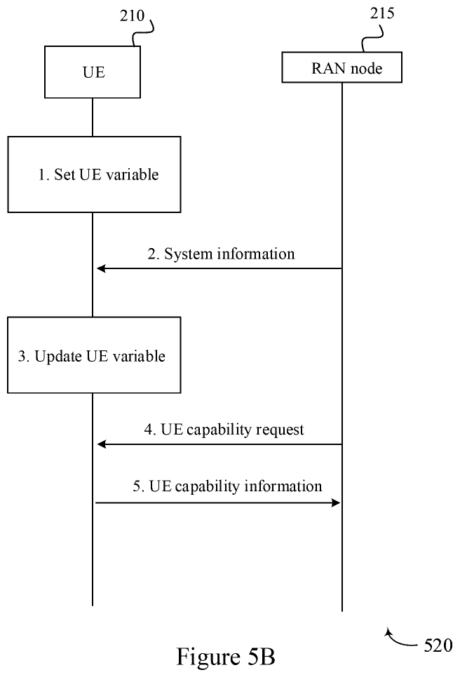

FIG. 5A illustrates a messaging flow 500 in accordance with aspects of the present disclosure and in support of a third example scenario. The messaging flow 500 may implement various aspects of the present disclosure described herein. For example, the messaging flow 500 may include the UE 210 and the RAN node 215, which may be examples of UEs and RAN nodes as described herein. In the following description of the messaging flow 500, the operations between the UE 210 and the RAN node 215 may be performed in different orders or at different times. Some operations may also be omitted, or other operations may be added. Although the UE 210 and the RAN node 215 are shown performing the operations of the messaging flow 500, some aspects of some operations may also be performed by other entities of the messaging flow 500 or by entities that are not shown in the messaging flow 500, or any combination thereof.

At step 1, the UE 210 enables a UE power saving mode (or a mode based on another temporary constraint or condition) due to a low battery level of the UE 210, while in the UE variable VarUE-CapabilityListStatus the static capability voiceOver6G and the dynamic capability aiml-CSI-Prediction are set to “supported,” and other parameters are set to “notSupported.”

At step 2, the UE 210 updates the UE variable. For example, the UE 210 updates the status of the dynamic capability drx-Adaptation from “notSupported” to “supported” to enable a discontinuous reception (DRX) mode at the UE 210 during the power saving mode (or other temporary constraint).

At step 3, the UE 210 transmits the UE capability information 220 to the RAN node 215. For example, the UE 210 sends an unsolicited UE capability information message to inform the RAN node 215 about latest or current statuses of its UE capabilities. The UE capability information 220 may contain the status of each of the static and dynamic capabilities (e.g., as stored in the UE variable VarUE-CapabilityListStatus) or may only contain statuses of the dynamic capabilities stored in the UE variable.

While the third example scenario is based on a power saving mode at the UE 210 being based on a condition or temporary constraint at the UE 210, other conditions or temporary constraints may cause the UE 210 to update the UE variable and/or transmit the unsolicited UE capability information message to inform the RAN node 215 about the latest or current statuses of its UE capabilities. Example conditions include one or more static capabilities of the UE 210 or one or more dynamic capabilities of the UE not being currently supported by the UE 210 (e.g., a feature or capability (e.g., IMS, AIML, intra-RAT mobility, or inter-RAT mobility) that is temporarily not supported by the UE 210, for a certain duration), the UE 210 is experiencing a temporary shortage of one or more available resources, conditions associated with a network (e.g., signal strength or channel quality) are suboptimal (e.g., below a suitable threshold) for supporting the one or more static capabilities of the UE 210 or the one or more dynamic capabilities of the UE 210, and so on.

FIG. 5B illustrates a messaging flow 520 in accordance with aspects of the present disclosure and in support of a fourth example scenario. The messaging flow 520 may implement various aspects of the present disclosure described herein. For example, the messaging flow 520 may include the UE 210 and the RAN node 215, which may be examples of UEs and RAN nodes as described herein. In the following description of the messaging flow 520, the operations between the UE 210 and the RAN node 215 may be performed in different orders or at different times. Some operations may also be omitted, or other operations may be added. Although the UE 210 and the RAN node 215 are shown performing the operations of the messaging flow 520, some aspects of some operations may also be performed by other entities of the messaging flow 520 or by entities that are not shown in the messaging flow 520, or any combination thereof.

At step 1, the UE 210 sets the UE variable. For example, the UE 210 sets the static capability voiceOver6G and the dynamic capability aiml-CSI-Prediction to “supported,” while other parameters are set to “notSupported.”

At step 2, the RAN node 215 transmits system information to the UE 210. For example, the RAN node 215 broadcasts, to all UEs located in its cell, system information that exposes the capabilities of the network. The contents of example system information (e.g., a SystemInformation message) are shown in Table 8, as follows:

TABLE 8

| Network capability | |
|---|---|
| parameters | Value |
| >AS release indicator | “Rel-21” |
| >voiceOver6G | “supported” |
| >handoverFR1-FR2 | “supported” |
| >sa-NR | “notSupported” |
| >aiml-CSI-Prediction | “notSupported” |
| >aiml-CSI-Compression | “notSupported” |
| >drx-Adaptation | “supported” |

At step 3, the UE 210 updates the UE variable. For example, in response to the exposed network capabilities, the UE 210 updates the status of the dynamic capability aiml-CSI-Prediction from “supported” to “notSupported.”

At step 4, the RAN node transmits a UE capability request to the UE 210. For example, the RAN node 215 sends a UE capability enquiry message to request the static and dynamic capabilities of the UE 210 for the 6G radio access technology. The UE capability enquiry message may include the parameters ue-CapabilityRequestList-Static and ue-CapabilityRequestList-Dynamic set to “true.”

At step 5, the UE 210 transmits the UE capability information 220 to the RAN node 215. The UE capability information 220 may contain a latest or current status of each of the static and dynamic capabilities (e.g., as stored in the UE variable VarUE-CapabilityListStatus) of the UE 210.

In some examples, the RAN node 215 may expose its network capabilities to the UE 210, such as to allow or enable the UE 210 to adapt its capability signaling to the RAN node 215. For example, the UE 210 may change the status of its capabilities or omit capabilities corresponding to features which are not supported by the network and indicated in the exposed network capabilities. Example network capabilities that may be exposed to the UE 210 include: an AS release indicator (e.g., Rel-21, Rel-22, Rel-23, and so on); a list of feature groups that are supported or not supported by the network, (e.g., AI/ML-enabled features, UE power saving features, and so on), a list of individual features that are supported or not supported by the network (e.g., AI/ML-enabled CSI measurement prediction, AI/ML-enabled CSI measurement compression, maximum multiple-input and multiple-output (MIMO) layers in UL/DL, maximum modulation order in UL/DL, and so on), and so on.

In some cases, the network may expose its capabilities to a UE (e.g., the UE 210) via broadcast (e.g., using a SystemInformation message) or per dedicated DL RRC messages, such as UECapabilityEnquiry, RRCReconfiguration, RRCSetup, and so on. In some cases, the network may expose its capabilities upon request from the UE 210. For example, the UE 210 sends the request as a new network capability enquiry message or via an RRCSetupComplete message to the network (e.g., the RAN node 215), which responds with a dedicated DL RRC message (e.g., UECapabilityEnquiry, RRCReconfiguration) having the network capabilities.

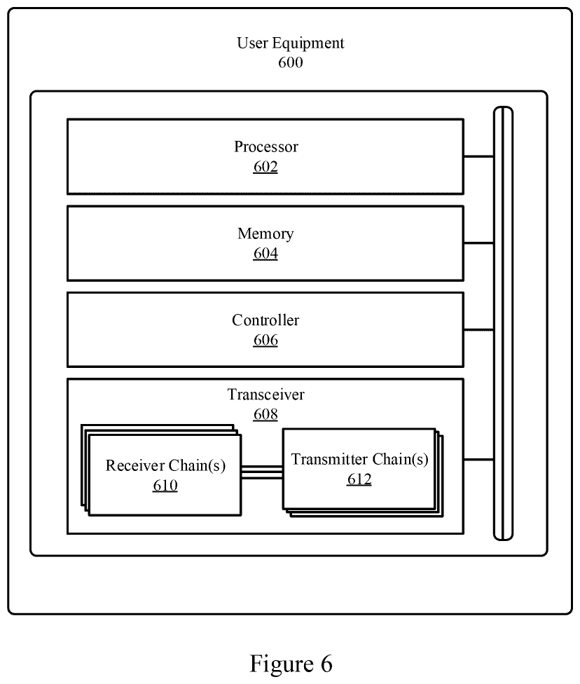

FIG. 6 illustrates an example of a UE 600 in accordance with aspects of the present disclosure. The UE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the UE 600 to perform various functions of the present disclosure.

The memory 604 may include volatile or non-volatile memory. The memory 604 may store computer-readable, computer-executable code including instructions when executed by the processor 602 cause the UE 600 to perform various functions described herein. The code may be stored in a non-transitory computer-readable medium such the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the UE 600 to perform one or more of the functions described herein (e.g., executing, by the processor 602, instructions stored in the memory 604). For example, the processor 602 may support wireless communication at the UE 600 in accordance with examples as disclosed herein. The UE 600 may be configured to support a means for storing a variable comprising a respective value for each static capability of a first set of one or more static capabilities and for each dynamic capability of a second set of one or more dynamic capabilities, and transmit UE capability information comprising the first set of one or more static capabilities of the UE or the second set of one or more dynamic capabilities of the UE, or both, wherein the first set of one or more static capabilities is different than the second set of one or more dynamic capabilities.

The controller 606 may manage input and output signals for the UE 600. The controller 606 may also manage peripherals not integrated into the UE 600. In some implementations, the controller 606 may utilize an operating system such as iOS®, ANDROID®, WINDOWS®, or other operating systems. In some implementations, the controller 606 may be implemented as part of the processor 602.

In some implementations, the UE 600 may include at least one transceiver 608. In some other implementations, the UE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas for receive the signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the processing the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

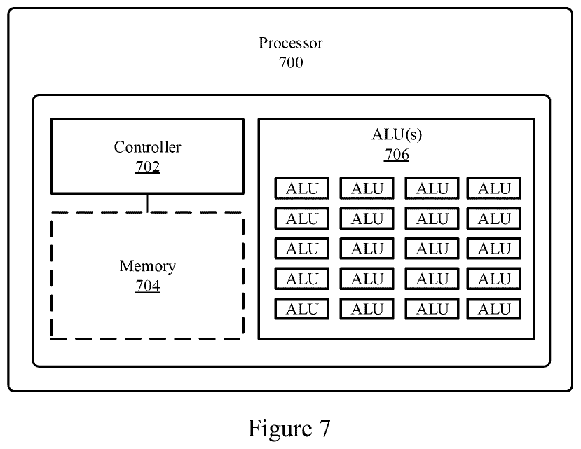

FIG. 7 illustrates an example of a processor 700 in accordance with aspects of the present disclosure. The processor 700 may be an example of a processor configured to perform various operations in accordance with examples as described herein. The processor 700 may include a controller 702 configured to perform various operations in accordance with examples as described herein. The processor 700 may optionally include at least one memory 704, which may be, for example, an L1/L2/L3 cache. Additionally, or alternatively, the processor 700 may optionally include one or more arithmetic-logic units (ALUs) 706. One or more of these components may be in electronic communication or otherwise coupled (e.g., operatively, communicatively, functionally, electronically, electrically) via one or more interfaces (e.g., buses).

The processor 700 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 700) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 702 may be configured to manage and coordinate various operations (e.g., signaling, receiving, obtaining, retrieving, transmitting, outputting, forwarding, storing, determining, identifying, accessing, writing, reading) of the processor 700 to cause the processor 700 to support various operations in accordance with examples as described herein. For example, the controller 702 may operate as a control unit of the processor 700, generating control signals that manage the operation of various components of the processor 700. These control signals include enabling or disabling functional units, selecting data paths, initiating memory access, and coordinating timing of operations.

The controller 702 may be configured to fetch (e.g., obtain, retrieve, receive) instructions from the memory 704 and determine subsequent instruction(s) to be executed to cause the processor 700 to support various operations in accordance with examples as described herein. The controller 702 may be configured to track memory address of instructions associated with the memory 704. The controller 702 may be configured to decode instructions to determine the operation to be performed and the operands involved. For example, the controller 702 may be configured to interpret the instruction and determine control signals to be output to other components of the processor 700 to cause the processor 700 to support various operations in accordance with examples as described herein. Additionally, or alternatively, the controller 702 may be configured to manage flow of data within the processor 700. The controller 702 may be configured to control transfer of data between registers, arithmetic logic units (ALUs), and other functional units of the processor 700.

The memory 704 may include one or more caches (e.g., memory local to or included in the processor 700 or other memory, such RAM, ROM, DRAM, SDRAM, SRAM, MRAM, flash memory, etc. In some implementations, the memory 704 may reside within or on a processor chipset (e.g., local to the processor 700). In some other implementations, the memory 704 may reside external to the processor chipset (e.g., remote to the processor 700).

The memory 704 may store computer-readable, computer-executable code including instructions that, when executed by the processor 700, cause the processor 700 to perform various functions described herein. The code may be stored in a non-transitory computer-readable medium such as system memory or another type of memory. The controller 702 and/or the processor 700 may be configured to execute computer-readable instructions stored in the memory 704 to cause the processor 700 to perform various functions. For example, the processor 700 and/or the controller 702 may be coupled with or to the memory 704, the processor 700, the controller 702, and the memory 704 may be configured to perform various functions described herein. In some examples, the processor 700 may include multiple processors and the memory 704 may include multiple memories. One or more of the multiple processors may be coupled with one or more of the multiple memories, which may, individually or collectively, be configured to perform various functions herein.

The one or more ALUs 706 may be configured to support various operations in accordance with examples as described herein. In some implementations, the one or more ALUs 706 may reside within or on a processor chipset (e.g., the processor 700). In some other implementations, the one or more ALUs 706 may reside external to the processor chipset (e.g., the processor 700). One or more ALUs 706 may perform one or more computations such as addition, subtraction, multiplication, and division on data. For example, one or more ALUs 706 may receive input operands and an operation code, which determines an operation to be executed. One or more ALUs 706 be configured with a variety of logical and arithmetic circuits, including adders, subtractors, shifters, and logic gates, to process and manipulate the data according to the operation. Additionally, or alternatively, the one or more ALUs 706 may support logical operations such as AND, OR, exclusive-OR (XOR), not-OR (NOR), and not-AND (NAND), enabling the one or more ALUs 706 to handle conditional operations, comparisons, and bitwise operations.

The processor 700 may support wireless communication in accordance with examples as disclosed herein. The UE processor 700 may be configured to support a means for storing a variable comprising a respective value for each static capability of a first set of one or more static capabilities and for each dynamic capability of a second set of one or more dynamic capabilities, and transmit UE capability information comprising the first set of one or more static capabilities of the UE or the second set of one or more dynamic capabilities of the UE, or both, wherein the first set of one or more static capabilities is different than the second set of one or more dynamic capabilities.

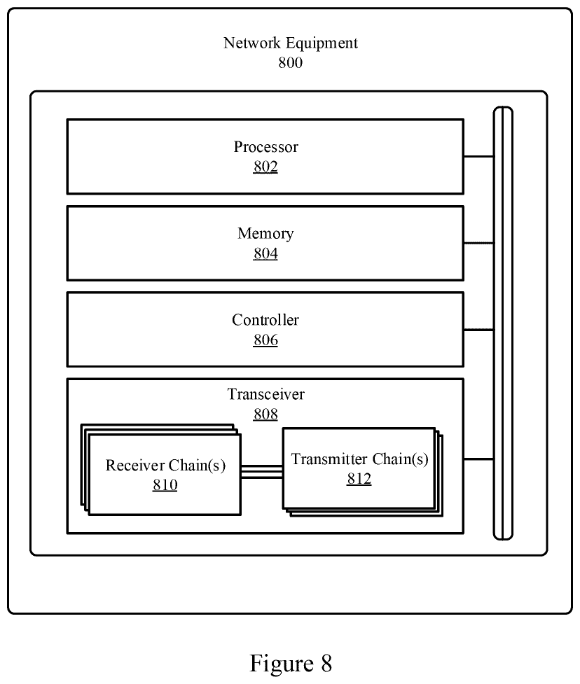

FIG. 8 illustrates an example of an NE 800 in accordance with aspects of the present disclosure. The NE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the NE 800 to perform various functions of the present disclosure.

The memory 804 may include volatile or non-volatile memory. The memory 804 may store computer-readable, computer-executable code including instructions when executed by the processor 802 cause the NE 800 to perform various functions described herein. The code may be stored in a non-transitory computer-readable medium such the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the NE 800 to perform one or more of the functions described herein (e.g., executing, by the processor 802, instructions stored in the memory 804). For example, the processor 802 may support wireless communication at the NE 800 in accordance with examples as disclosed herein. The NE 800 (e.g., a RAN node) may be configured to support a means for transmitting, to a UE, a UE capability request for a first set of one or more static capabilities of the UE or a second set of one or more dynamic capabilities of the UE, or both and receiving a UE capability response based at least in part on the received UE capability request, wherein the UE capability response comprises UE capability information.

The controller 806 may manage input and output signals for the NE 800. The controller 806 may also manage peripherals not integrated into the NE 800. In some implementations, the controller 806 may utilize an operating system such as iOS®, ANDROID®, WINDOWS®, or other operating systems. In some implementations, the controller 806 may be implemented as part of the processor 802.

In some implementations, the NE 800 may include at least one transceiver 808. In some other implementations, the NE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas for receive the signal over the air or wireless medium. The receiver chain 810 may include at least one amplifier (e.g., a low-noise amplifier (LNA)) configured to amplify the received signal. The receiver chain 810 may include at least one demodulator configured to demodulate the receive signal and obtain the transmitted data by reversing the modulation technique applied during transmission of the signal. The receiver chain 810 may include at least one decoder for decoding the processing the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

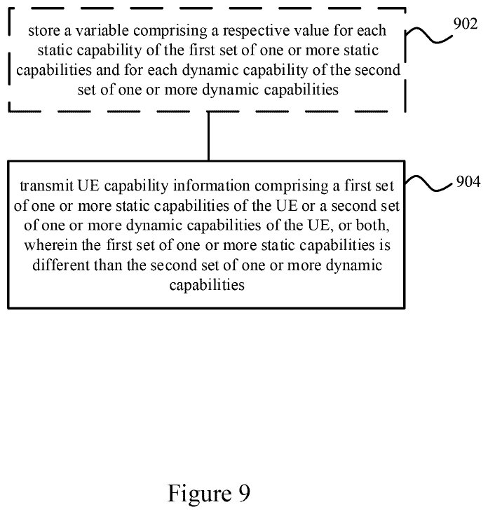

FIG. 9 illustrates a flowchart of a method in accordance with aspects of the present disclosure. The operations of the method may be implemented by a UE as described herein. In some implementations, the UE may execute a set of instructions to control the function elements of the UE to perform the described functions.

At 902, the method may include, optionally, storing a variable comprising a respective value for each static capability of a first set of one or more static capabilities and for each dynamic capability of a second set of one or more dynamic capabilities. The operations of 902 may be performed in accordance with examples as described herein. In some implementations, aspects of the operations of 902 may be performed by a UE as described with reference to FIG. 6.

At 904, the method may include transmitting UE capability information comprising the first set of one or more static capabilities of the UE or the second set of one or more dynamic capabilities of the UE, or both, wherein the first set of one or more static capabilities is different than the second set of one or more dynamic capabilities.

The operations of 904 may be performed in accordance with examples as described herein. In some implementations, aspects of the operations of 904 may be performed by a UE as described with reference to FIG. 6.

It should be noted that the method described herein describes a possible implementation, and that the operations and the steps may be rearranged or otherwise modified and that other implementations are possible.

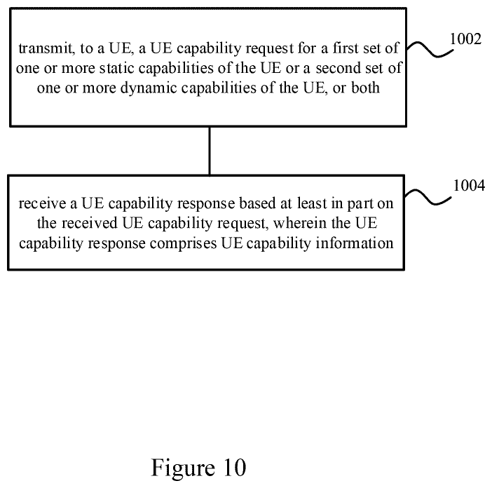

FIG. 10 illustrates a flowchart of a method in accordance with aspects of the present disclosure. The operations of the method may be implemented by an NE as described herein. In some implementations, the NE may execute a set of instructions to control the function elements of the NE to perform the described functions.

At 1002, the method may include transmitting, to a UE, a UE capability request for a first set of one or more static capabilities of the UE or a second set of one or more dynamic capabilities of the UE, or both. The operations of 1002 may be performed in accordance with examples as described herein. In some implementations, aspects of the operations of 1002 may be performed by an NE as described with reference to FIG. 8.

At 1004, the method may include receiving a UE capability response based at least in part on the received UE capability request, wherein the UE capability response comprises UE capability information. The operations of 1004 may be performed in accordance with examples as described herein. In some implementations, aspects of the operations of 1004 may be performed by an NE as described with reference to FIG. 8.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
one or more memories; and
one or more processors coupled with the one or more memories and individually or collectively configured to cause the UE to:
transmit UE capability information comprising a first set of one or more static capabilities of the UE or a second set of one or more dynamic capabilities of the UE, or both, wherein the first set of one or more static capabilities is different than the second set of one or more dynamic capabilities.

2. The UE of claim 1, wherein the one or more processors are further individually or collectively configured to cause the UE to:
receive a UE capability request for the first set of one or more static capabilities of the UE or the second set of one or more dynamic capabilities of the UE, or both; and
transmit a UE capability response based at least in part on the received UE capability request, wherein the UE capability response comprises the UE capability information.

3. The UE of claim 1, wherein the one or more processors are further individually or collectively configured to cause the UE to:
store a variable comprising a respective value for each static capability of the first set of one or more static capabilities and for each dynamic capability of the second set of one or more dynamic capabilities,
wherein the UE capability information is based at least in part on the stored variable.

4. The UE of claim 3, wherein the respective value for each static capability of the first set of one or more static capabilities and for each dynamic capability of the second set of one or more dynamic capabilities is indicative of whether a respective static capability or a respective dynamic capability is supported by the UE, not supported by the UE, supported by the UE and applicable according to a current configuration, or supported and not applicable according to the current configuration.

5. The UE of claim 4, wherein the one or more processors are further individually or collectively configured to cause the UE to:
receive a reconfiguration message or a system information message; and
update the respective value for one or more static capabilities of the first set of one or more static capabilities or for one or more dynamic capabilities of the second set of one or more dynamic capabilities based at least in part on the received reconfiguration message or the received system information message.

6. The UE of claim 5, wherein the UE capability information comprising the first set of one or more static capabilities of the UE or the second set of one or more dynamic capabilities of the UE, or both, is transmitted based at least in part on the received reconfiguration message or the received system information message.

7. The UE of claim 5, wherein the one or more processors are further individually or collectively configured to cause the UE to:
transmit a response message based at least in part on the received reconfiguration message,
wherein the response message indicates a failure for reconfiguration and a cause value, and
wherein the cause value is indicative of the failure for reconfiguration being based at least in part on whether the respective static capability or the respective dynamic capability is not supported by the UE or supported by the UE and not applicable according to the current configuration.

8. The UE of claim 4, wherein the one or more processors are further individually or collectively configured to cause the UE to:
update the respective value for one or more static capabilities of the first set of one or more static capabilities or for one or more dynamic capabilities of the second set of one or more dynamic capabilities based at least in part on a condition.

9. The UE of claim 8, wherein the condition comprises a low power mode being enabled or disabled for the UE.

10. The UE of claim 8, wherein the condition comprises:
one or more static capabilities of the UE or one or more dynamic capabilities of the UE are not currently supported by the UE;
the UE is experiencing a temporary shortage of one or more available resources; or
conditions associated with a network are suboptimal for supporting the one or more static capabilities of the UE or the one or more dynamic capabilities of the UE.

11. The UE of claim 8, wherein the UE capability information comprising the first set of one or more static capabilities of the UE or the second set of one or more dynamic capabilities of the UE, or both, is transmitted in response to the updated respective value for one or more static capabilities of the first set of one or more static capabilities or for one or more dynamic capabilities of the second set of one or more dynamic capabilities.

12. A network entity for wireless communication, comprising:
one or more memories; and
one or more processors coupled with the one or more memories and individually or collectively configured to cause the network entity to:
transmit, to a user equipment (UE), a UE capability request for a first set of one or more static capabilities of the UE or a second set of one or more dynamic capabilities of the UE, or both; and
receive a UE capability response based at least in part on the received UE capability request, wherein the UE capability response comprises UE capability information.

13. The network entity of claim 12, wherein the one or more processors are further individually or collectively configured to cause the network entity to receive the UE capability response in response to a radio resource control (RRC) reconfiguration message or a radio resource control (RRC) system information message.

14. The network entity of claim 12, wherein the one or more processors are further individually or collectively configured to cause the network entity to receive the UE capability response via a radio resource control (RRC) UE capability information message or an RRC reconfiguration failure message.

15. A method performed by a user equipment (UE), the method comprising:
transmitting UE capability information comprising a first set of one or more static capabilities of the UE or a second set of one or more dynamic capabilities of the UE, or both, wherein the first set of one or more static capabilities is different than the second set of one or more dynamic capabilities.

16. The method of claim 15, further comprising:
receiving a UE capability request for the first set of one or more static capabilities of the UE or the second set of one or more dynamic capabilities of the UE, or both; and
transmitting a UE capability response based at least in part on the received UE capability request, wherein the UE capability response comprises the UE capability information.

17. The method of claim 15, further comprising:
storing a variable comprising a respective value for each static capability of the first set of one or more static capabilities and for each dynamic capability of the second set of one or more dynamic capabilities,
wherein the UE capability information is based at least in part on the stored variable.

18. The method of claim 17, wherein the respective value for each static capability of the first set of one or more static capabilities and for each dynamic capability of the second set of one or more dynamic capabilities is indicative of whether a respective static capability or a respective dynamic capability is supported by the UE, not supported by the UE, supported by the UE and applicable according to a current configuration, or supported and not applicable according to the current configuration.

19. A method performed by a network entity, the method comprising:
transmitting, to a user equipment (UE), a UE capability request for a first set of one or more static capabilities of the UE or a second set of one or more dynamic capabilities of the UE, or both; and
receiving a UE capability response based at least in part on the received UE capability request, wherein the UE capability response comprises UE capability information.

20. The method of claim 19, wherein the UE capability response is received in response to a radio resource control (RRC) reconfiguration message or a radio resource control (RRC) system information message.
